(19) United States
(12) Patent Application Publication
(10) Pub. No.: US 2012/0278038 A1
(43) Pub. Date: Nov. 1, 2012

(54) ESTIMATING MONTHLY HEATING OIL CONSUMPTION FROM FISCAL YEAR OIL CONSUMPTION DATA USING MULTIPLE REGRESSION AND HEATING DEGREE DAY DENSITY FUNCTION

(75) Inventors: Lianjun An, Yorktown Heights, NY (US); Huijing Jiang, White Plains, NY (US); Young Min Lee, Old Westbury, NY (US); Fei Liu, Mt. Kisco, NY (US); Estepan Meliksetian, Yorktown Heights, NY (US); Chandrasekhara K. Reddy, Kinnelon, NJ (US)

(73) Assignee: INTERNATIONAL BUSINESS MACHINES CORPORATION, Armonk, NY (US)

(21) Appl. No.: 13/098,076

(22) Filed: Apr. 29, 2011

(51) Int. Cl. G06F 19/00

(52) U.S. Cl. 702/181

(57) ABSTRACT

Estimating monthly heating oil consumption of a building that uses heating oil and non-oil source of energy, may include separating by applying statistical models, yearly consumption of oil data associated with the building into base load oil consumption and space heating oil consumption. The separating may also include determining monthly base load oil consumption associated with the building. Monthly space heating consumption of oil may be estimated by applying a heating degree day density function to the space heating oil consumption. The monthly space heating consumption may be aggregated with the monthly base load oil consumption to estimate the monthly heating oil consumption.

### FIELD

The present application relates generally to energy consumption in buildings and more particularly to estimating monthly heating oil consumption from fiscal year oil consumption data using multiple regression and heating degree day density function.

### BACKGROUND

In order to reduce energy consumption in buildings, one should understand how much energy is consumed in each time periods (typically monthly, but it can be daily) and by energy type (electricity, steam, chilled water, natural gas and fuel oil). Most energy types have meter to measure energy consumption (e.g., electricity, natural gas, steam, and others). However, fuel oil is delivered to a premise and filled in the oil tank per demand or a few times in a year, and typically only fiscal year data for oil usage is available.

Known methods determine monthly oil usage data by dividing the yearly usage data by 12 months, producing equal data for each of the 12 months in a year. However, such data does not accurately reflect the oil usage in a given month. For instance, oil usage may be greater for winter or colder months than for summer or warmer months. That is, typically more oil is used to heat the building space during the cold months while no oil may be used for such purpose during the summer months. In addition, oil may be consumed for purposes other than heating the building, which purposes may not depend on the weather or the temperature. Therefore, accurately determining oil consumption on a monthly basis (or other finer periodic basis than yearly) becomes a challenging problem.

### BRIEF SUMMARY

A method and system for estimating monthly heating oil consumption of a building that uses heating oil and non-oil source of energy may be provided. The method, in one aspect, may include receiving yearly consumption of oil data associated with the building, and separating, by applying statistical models, the yearly consumption of oil data into base load oil consumption and space heating oil consumption. The separating step further may include determining monthly base load oil consumption associated with the building. The method may also include estimating monthly space heating consumption of oil by applying a heating degree day density function to the space heating oil consumption, and summing the monthly space heating consumption and the monthly base load oil consumption to estimate the monthly heating oil consumption.

In another embodiment, a method for estimating monthly heating oil consumption of a selected building that uses heating oil and non-oil source of energy may include developing a first regression model to separate monthly base load energy usage from heating energy usage, using data collected from a plurality of buildings that do not use oil for energy. The method may also include building a second regression model for the monthly base load energy usage based on one or more building characteristics. The method may further include predicting selected building's monthly base load usage by applying the developed second regression model, estimating selected building's monthly non-oil base load usage attributed to non-oil energy source by applying the first regression model, and determining monthly base load oil consumption associated with a selected building by taking the difference between the predicted monthly base load usage associated with the building and the estimated monthly non-oil base load usage of the building. The method may also include estimating monthly space heating consumption of oil by applying a heating degree day density function to the space heating oil consumption, and summing the monthly space heating consumption and the monthly base load oil consumption to estimate the monthly heating oil consumption.

A system for estimating monthly heating oil consumption of a building that uses heating oil and non-oil source of energy, in one aspect, may include a plurality of statistical models stored in memory, including a first formulation that describes energy consumption in terms of base load usage and heating usage, and a second formulation that describes energy usage for base load in terms of building characteristics. The system may also include a module operable to separate, by applying the statistical models, yearly consumption of oil data associated with a selected building into base load oil consumption and space heating oil consumption. The separating may further include determining monthly base load oil consumption associated with the selected building. The module may be further operable to estimate monthly space heating consumption of oil by applying a heating degree day density function to the space heating oil consumption. The module may be also operable to sum the monthly space heating consumption and the monthly base load oil consumption to estimate the monthly heating oil consumption.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a method of estimating monthly heating oil consumption from fiscal year oil consumption data in one embodiment of the present disclosure.

FIG. 2 is a flow diagram illustrating detailed steps in one embodiment of the present disclosure for developing statistical model shown in FIG. 1 at 102.

FIG. 3 is a flow diagram illustrating detailed steps in one embodiment of the present disclosure for computing base load oil consumption shown in FIG. 1 at 104.

FIG. 4 is a flow diagram illustrating detailed steps in one embodiment of the present disclosure for distributing space heating oil use shown in FIG. 1 at 106.

FIG. 5 shows components in one embodiment of the present disclosure that may run or implement the methodologies of the present disclosure.

FIG. 6 is a graph illustrating base load separation in one embodiment of the present disclosure.

FIG. 7 illustrates oil usage distribution in one embodiment of the present disclosure.

### DETAILED DESCRIPTION

In order to reduce energy consumption in buildings, one should understand how much energy is consumed in each time period (e.g., monthly or even daily) and what energy type is consumed (e.g., electricity, steam, chilled water, natural gas and fuel oil). Most energy types have meter to measure energy consumption (e.g., electricity, natural gas, steam and others). However, fuel oil is delivered to fill the oil tank. The delivery of oil and filling of the oil tank occur few times in a year, and typically only fiscal year data is available. Therefore, there is a need for an accurate method for distributing fiscal year data of oil consumption into monthly consumption. The present disclosure shows how monthly heating oil consumption may be estimated from fiscal year oil consumption data. An embodiment of the present disclosure provides multiple regression and HDD density function methods for computing the monthly (or other periodic) oil consumption.

A methodology of the present disclosure in one embodiment separates the consumption of oil in a building that may remain constant or substantially constant from period to period, from the consumption of oil in the building that varies over the months, for instance, because the use may depend on factors that change over the months such as the outside temperature or weather. For the amount of consumption of oil that depends on the outside temperature or weather, heating degree day (HDD) density function is used to distribute the yearly consumption over the months. In some buildings oil may be used as source of energy for heating as well as for other purposes (referred to as base load) whose usage remain relatively constant throughout the periods. In addition, other energy source (e.g., steam, gas, electricity) may be used for part of the base load. Therefore, the present disclosure also separates the base load consumption into those that use oil and those that do not use oil. In the present disclosure in one embodiment, the separation of energy consumption into base load consumption and heating consumption are determined from using the data borrowed from buildings that do not use oil, as will be explained more fully below.

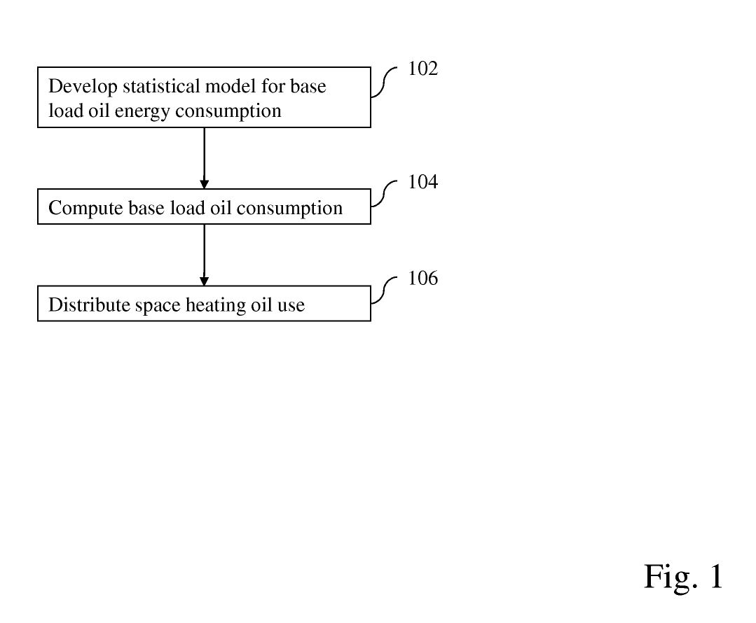

FIG. 1 is a flow diagram illustrating a method of estimating monthly heating oil consumption from fiscal year oil consumption data in one embodiment of the present disclosure. In many buildings and households, oil is used to heat the inside area or space as well as for other purpose, for instance, for heating water. A building may include any enclosed construction or structure, for instance, with a roof, one or more doors and windows, and may be one floored or have multiple floors. Examples include an office building, a house, a school building, and others. Base load refers to use of energy for other than heating the space or area. Oil consumed for uses other than for heating the space is referred to herein as base load consumption of oil or base load oil consumption. Oil consumed for heating the space or area of a building is referred to as space heating consumption of oil or space heating oil consumption in the present disclosure. Thus, total oil consumption for a building may be expressed as the sum of the base load consumption of oil and the space heating consumption of oil.

At 102, statistical models may be developed for base load (e.g., hot water) consumption of oil. At 104, base load consumption of oil may be computed based on the developed statistical models. At 106, space heating oil consumption may be distributed monthly based on a heating degree day (HDD) density. Heating degree day (HDD) refers to the difference between the outside temperature and base temperature. The base temperature is the outside air temperature above which a building needs no heating. The base temperature depends on the characteristics of the building. However, HDD are often defined with base temperatures of 18° C. (65° F.), or 15.5° C. (60° F.). In one embodiment of the present disclosure, different building may have different base temperature and HDD. The monthly base load consumption of oil is added with the monthly space heating oil consumption to determine the total monthly oil consumption.

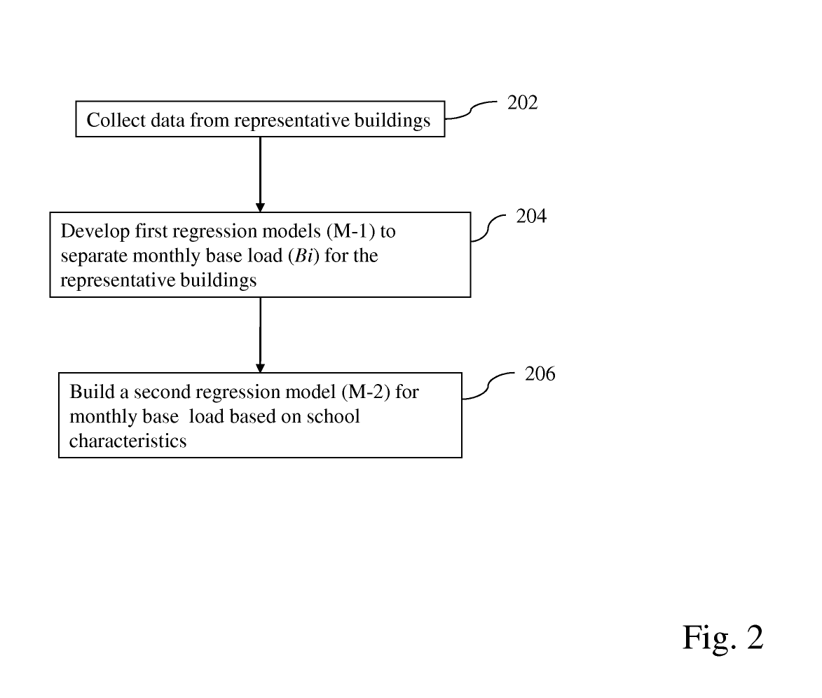

FIG. 2 is a flow diagram illustrating detailed steps in one embodiment of the present disclosure for developing statistical models shown in FIG. 1 at 102. A regression model using data from other energy source (other than oil) is developed. For instance, consider a school building as an example building. At 202, data may be collected from a sample of multiple schools, (also referred to as representative schools) that use other sources of energy (e.g., steam only, gas only, or others) and do not use oil. Examples of non-oil energy consumption data may include, but are not limited to, metered data showing how much electricity was consumed, how much gas was consumed, how much steam was consumed, for instance, in a given month, and others. Such types of energy sources typically have monthly consumption data available (i.e., how much of the source is consumed per month). For example, schools that use gas for operation may have gas usage readings and associated gas bills each month. Similarly, schools that use steam may have the monthly steam usage data.

At 202, a regression model (referred to as M-1 or first regression model for the sake of clarity and explanation only) may be developed to separate monthly base load (Bᵢ) for the representative schools as follows using the collected data for each school building:

Sᵢₜ=Bᵢ+βᵢ·HDDₜ·GFAᵢ+εᵢₜ (M-1)

where

Sᵢₜ is other energy source (e.g., steam) usage for building i at month t,

Bᵢ is monthly base load for building i,

βᵢ is a coefficient or slope associated with energy usage for heating,

HDDₜ is heating degree day at month t,

GFAᵢ is gross flow area (e.g., square feet),

εᵢₜ is an error term accounting for part of energy that may not be explained by the regression model, for example, not attributed to base load or heating usage.

The above regression model (M-1) formulates energy usage in a building in terms of base load usage and heating usage.

In one embodiment of the present disclosure, a plurality of the above models may be generated, for example, for each building (or school in this example), e.g., i=1 to n, where n is the number of buildings. In one aspect, data from a group of schools having the same or similar characteristics may be used for purposes of generating a regression model for a building with those particular characteristics. Thus, a plurality of the above regression models may be generated associated respectively with a plurality of buildings, where each of the plurality of buildings may be of different characteristics.

Another regression model (referred to as M-2 or second regression model) may be developed for monthly energy consumption associated with the base load, based on school characteristics. That is, M-2 models the base load as a function of school characteristics, taking the form generally as

Bᵢ=Xᵢβ+εᵢ (M-2)

where

Bᵢ is monthly base load for building i estimated from M-1,

β is a coefficient or slope associated with building characteristics,

Xᵢ represents one or more building characteristics, such as GFA, operating hours, other characteristic,

εₜ is an error term accounting for part of energy that may not be explained by the regression model, for example, base load usage not attributed to building characteristics.

Examples of building characteristics data used by this model may include, but are not limited to, GFA, age of the building and its equipment, occupancy related data, operating hours, number of equipment, and others conditions of the building corresponding to the time period of the energy consumption data. Examples of building operation and activity data may include, but are not limited to, data describing how the building is operated and the activities performed in the building corresponding to the time period of the energy consumption data such as the operating hours of a building and whether a building is open during the weekends.

Model M-2 can be used to predict the base load for a particular school, given its school characteristics. In particular, using M-2 above, β corresponding to one or more building characteristics may be determined based on Bᵢ, monthly base load for building i estimated from M-1. The determined β may be then used with the corresponding school characteristics in model M-2 to predict the base load Bᵢ for those schools that are using oil as energy source.

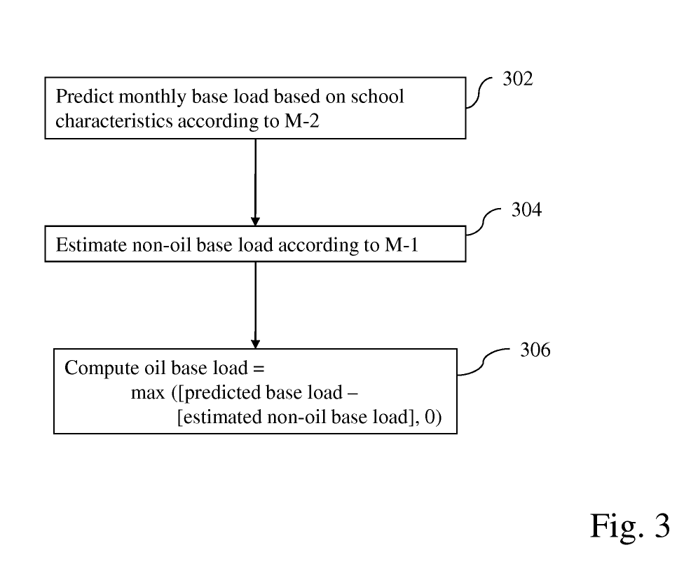

FIG. 3 is a flow diagram illustrating detailed steps in one embodiment of the present disclosure for computing base load oil consumption shown in FIG. 1 at 104. At 302, monthly energy consumption associated with base load (non-heating use) may be predicted based on school characteristics according to the second regression model (M-2). This model predicts energy source usage for base load only, i.e., excluding the space heating usage. However, the energy source usage may include a mix of sources, e.g., oil and other sources. For instance, a building may use oil for hot water, gas for cooking, and electricity for lighting. Since model M-2 predicts the overall base load, the non-oil base load is subtracted from the overall base load in order to compute the base load for oil as shown at 304 and 306.

At 304, monthly non-oil energy source consumption for base load (e.g., steam) is estimated according to M-1. For instance, Bᵢ for the school that is using oil (for heating and some of base load) is estimated from M-1, using the non-oil energy usage data that is available (e.g., monthly gas or electricity bills and usage data) associated with that school. At 306, base load consumption of oil for the school is computed as the maximum of the difference between the predicted base load at 302 and the estimated non-oil base load at 304, and 0, for example, as follows:

base load oil consumption=max([predicted base load]−[estimated non-oil base load], 0)

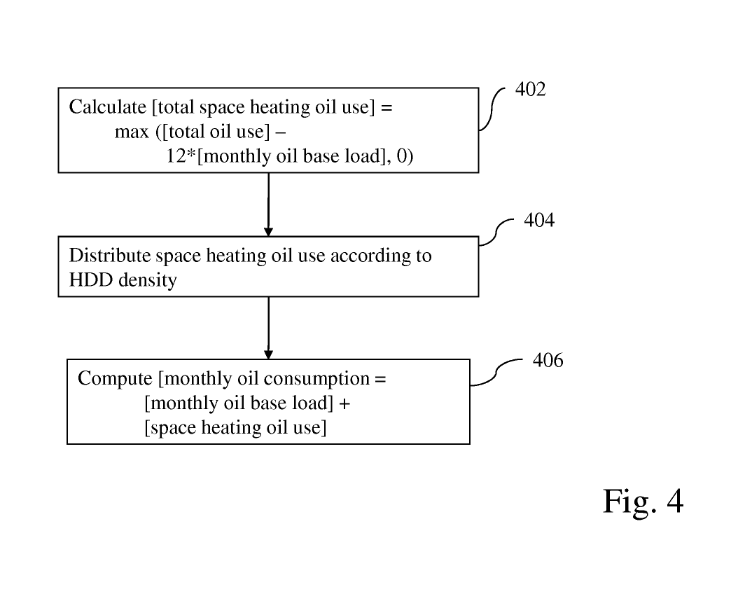

FIG. 4 is a flow diagram illustrating detailed steps in one embodiment of the present disclosure for distributing space heating oil use shown in FIG. 1 at 106. At 402, total space heating oil use is computed as the maximum of the difference between total yearly oil use and 12 times the monthly oil base load computed at 306 in FIG. 3, and 0 as follows:

[total space heating oil use]=max([total oil use]−12*[monthly oil base load], 0).

The above equation assumes the total use is yearly use, hence monthly oil base load is multiplied by 12. If the total use is other than yearly, the computation above may be adjusted accordingly.

At 404, the space heating oil use is distributed according to HDD density, e.g.:

$$\frac{{HDD}_{t}}{{\sum }_{t ∈ ( {t}_{1} , {t}_{2} )} {HDD}_{t}} \times [ total heating ]$$

In the above equation, HDDₜ represents heating degree day (HDD) at month t. t₁ represents a time the oil tank is filled and t₂ represents the next time that the same oil tank is filled, for instance yearly. “total heating” represents the total space heating oil use from t₁ to t₂, for instance, computed as described above, e.g., as the difference between the total oil use and base load oil use as computed using M-1 and M-2. The above HDD density equation computes the monthly space heating oil use.

At 406, monthly oil consumption is computed as the sum of the monthly oil base load computed at 306 in FIG. 3 and the monthly space heating oil use computed at 404.

The following describes different methods for determining monthly oil usage depending on whether a selected building uses oil only or combination of oil with other sources of energy for running the operations of the building (e.g., space heating, hot water, cooking, and others). Initially, buildings that do not use oil at all for source of energy may be analyzed. For instance, buildings that only use steam may be analyzed, e.g., the monthly energy consumption data collected from those non-oil use buildings are used in the regression model M-1, from which the energy usage associated with the base load in those buildings are estimated. Model M-2 may be built based on the building characteristics using the base load usage estimated using M-1.

Then, for a selected building that uses oil and other sources of energy (and use oil for heating), the monthly total base load may be predicted based on the building characteristics using M-2. Monthly non-oil usage associated with the base load (Bᵢ) of this selected building may be estimated using M-1 since monthly non-oil energy usage data (Sᵢ) would be available. The estimated non-oil usage for the base load may be separated from oil usage for the base load by subtracting the estimated non-oil usage for the base load from predicted total base load, producing monthly base load oil consumption for this selected building. Then the yearly oil consumption for the space heating may be determined by subtracting 12 times the base load oil consumption from the yearly total oil consumption. To determine the monthly oil usage from space heating, the determined yearly oil consumption for the space heating is distributed according to HDD density.

For a building that only uses oil, the monthly total base load may be predicted based on the building characteristics using M-2. Then the yearly oil consumption for the space heating may be determined by subtracting 12 times the base load oil consumption from the yearly total oil consumption. To determine the monthly oil usage from space heating, the determined yearly oil consumption for the space heating is distributed according to HDD density.

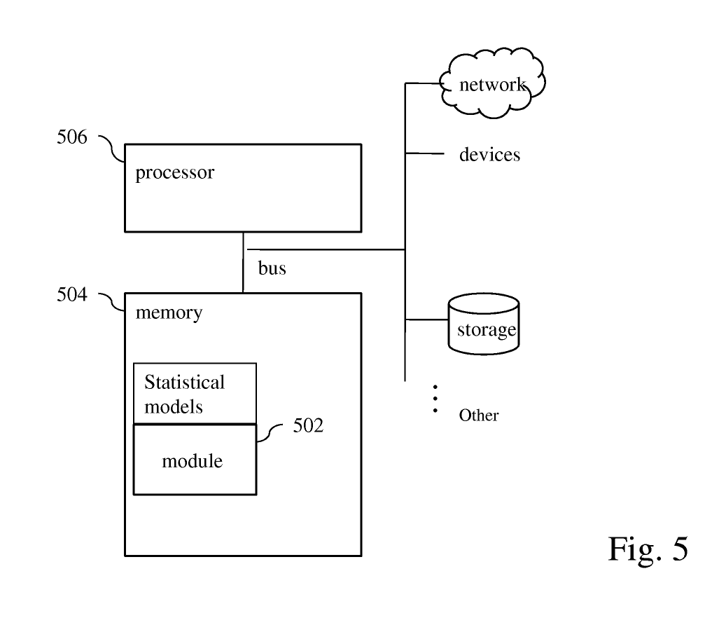

FIG. 5 shows components in one embodiment of the present disclosure that may run or implement the methodologies of the present disclosure. An analytical module 502, which may be stored and loaded into memory 504 of a computer system, may generate statistical models based on data collected from one or more representative buildings. A processor 506 may execute the analytical module 502 which includes program logic to use the statistical models and perform analysis to determine the monthly oil consumption in a selected building, for instance, as describe above. The collected data may be stored in a storage device and loaded into memory and/or received via a network connected to the computer system. Any other methodology may be used to collect and receive the data.

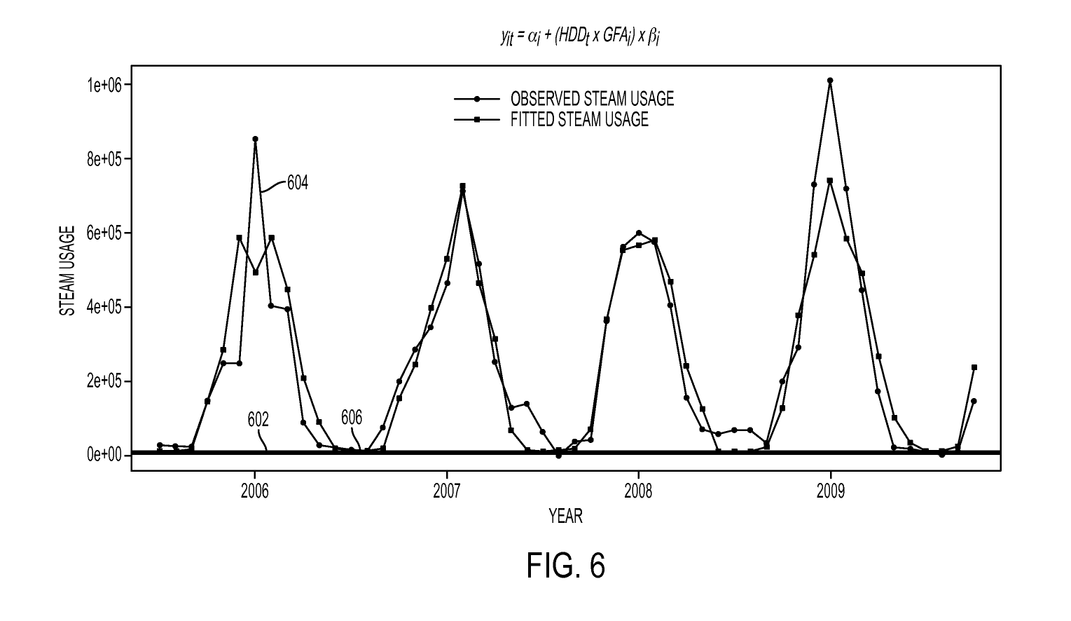

FIG. 6 is a graph illustrating the base load separation in one embodiment of the present disclosure. Base load (shown as αᵢ) 602 is shown as constant. Consumption of energy due to heating depends on HDD and is larger in the winter months (US East Coast area) 604 than in the summer months 606.

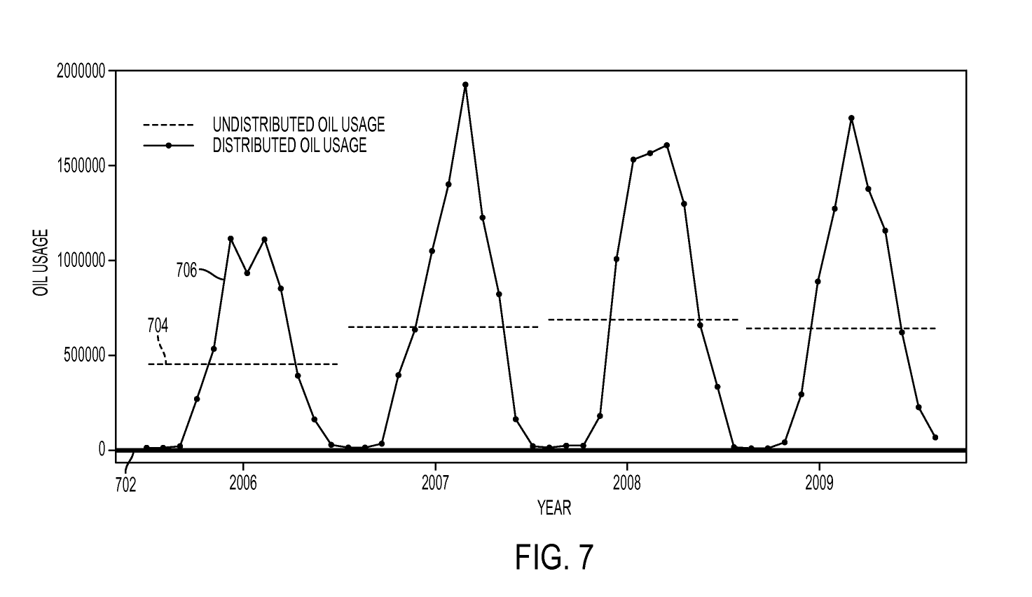

FIG. 7 illustrates oil usage distribution in one embodiment of the present disclosure. The dotted lines show a typical simple method that divides yearly oil consumption data by 12 to derive monthly consumption. This results in equal monthly consumption for all 12 months which typically do not represent the true monthly usage, which in actuality varies along the course of the months (shown at 704). The methodology of the present disclosure accurately derives the monthly consumption by applying HDD density. In this graph, base load is shown by the line at 702. Monthly oil consumption is shown by the line at 706 as distributed according to HDD.

In the above explanation, the time period t is selected as being a month. That is, monthly oil consumption was determined from the oil consumption data that included a plurality of months, i.e., yearly data. It should be understood, however, that other periodic time may be used. In addition, the data from which the periodic time oil consumption is determined, need not be limited to yearly data. Thus, for example, the above methodologies may be used to determine different periodic oil consumption (e.g., other than monthly), and also using different available data (e.g., other than yearly data).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which - when loaded in a computer system - is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for estimating monthly heating oil consumption of a building that uses heating oil and non-oil source of energy, comprising:
receiving yearly consumption of oil data associated with the building;
separating, by a processor applying statistical models, the yearly consumption of oil data into base load oil consumption and space heating oil consumption, the separating step further including determining monthly base load oil consumption associated with the building;
estimating monthly space heating consumption of oil by applying a heating degree day density function to the space heating oil consumption; and
summing the monthly space heating consumption and the monthly base load oil consumption to estimate the monthly heating oil consumption.

2. The method of claim 1, wherein the statistical models include a first regression model that formulates monthly energy source usage in terms of monthly base load usage and monthly heating usage, and a second regression model that formulates the monthly base load usage in terms of building characteristics.

3. The method of claim 2, wherein the step of separating includes:
developing the first regression model based on monthly energy usage data associated with one or more buildings that do not use oil as energy source;
determining first monthly base load usage from the developed first regression model;
developing the second regression model based on said first monthly base load usage;
predicting second monthly base load usage associated with the building using the developed second regression model;
estimating monthly non-oil base load usage of the building attributed to non-oil energy source by applying the first regression model using monthly non-oil energy source usage data associated with the building; and
determining the monthly base load oil consumption associated with the building by taking the difference between the predicted second monthly base load usage associated with the building and the monthly non-oil base load usage of the building.

4. The method of claim 2, wherein the building characteristics include size of the building, gross floor area, age of the building and its equipment, occupancy related data, operating hours, number of equipment, operating hours, or combinations thereof.

5. The method of claim 2, wherein the first regression model includes
Sᵢₜ=Bᵢ+βᵢ·HDDₜ·GFAᵢ+εᵢₜ, wherein
Sᵢₜ represents other energy source (e.g., steam) usage for building i at month t,
Bᵢ represents monthly base load for building i,
βᵢ represents a coefficient associated with energy usage for heating,
HDDₜ represents heating degree day at month t,
GFAᵢ represents gross flow area,
εᵢₜ represents an error term accounting for part of energy use not attributed to heating or base load consumption.

6. The method of claim 2, wherein the second regression model includes
Bᵢ=Xᵢβ+εᵢ, wherein
Bᵢ represents monthly base load for building i estimated from the first regression model,
β represents a coefficient associated with base load usage due to a building characteristic,
Xᵢ represents one or more building characteristic,
εₜ is an error term accounting for part of energy usage not attributed to building characteristic.

7. The method of claim 1, wherein the applying a heating degree day density function to the space heating oil consumption includes multiplying the space heating oil consumption by
$$\frac{{HDD}_{t}}{{\sum }_{t ∈ ( {t}_{1} , {t}_{2} )} {HDD}_{t}} ,$$
wherein HDDₜ represents heating degree day (HDD) at month t. t₁ represents beginning and ending time periods respectively associated with period of the space heating oil consumption.

8. A system for estimating monthly heating oil consumption of a building that uses heating oil and non-oil source of energy, comprising:
a processor;
a plurality of statistical models stored in memory, including a first formulation that describes energy consumption in terms of base load usage and heating usage, and a second formulation that describes energy usage for base load in terms of building characteristics; and
a module operable to execute on the processor, the module further operable to separate, by applying the statistical models, yearly consumption of oil data associated with a selected building into base load oil consumption and space heating oil consumption, the module further operable to determine monthly base load oil consumption associated with the selected building,
the module further operable to estimate monthly space heating consumption of oil by applying a heating degree day density function to the space heating oil consumption; and sum the monthly space heating consumption and the monthly base load oil consumption to estimate the monthly heating oil consumption.

9. The system of claim 8, wherein the first formulation includes a first regression model that formulates monthly energy source usage in terms of monthly base load usage and monthly heating usage, and the second formulation includes a second regression model that formulates the monthly base load usage in terms of building characteristics.

10. The system of claim 9, wherein the module is operable to separate the yearly consumption of oil data by developing the first regression model based on monthly energy usage data associated with one or more buildings that do not use oil as energy source, determining first monthly base load usage from the developed first regression model, developing the second regression model based on said first monthly base load usage, predicting second monthly base load usage associated with the building using the developed second regression model, estimating monthly non-oil base load usage of the building attributed to non-oil energy source by applying the first regression model using monthly non-oil energy source usage data associated with the building, and determining the monthly base load oil consumption associated with the building by taking the difference between the predicted second monthly base load usage associated with the building and the monthly non-oil base load usage of the building.

11. The system of claim 9, wherein the building characteristics include size of the building, gross floor area, age of the building and its equipment, occupancy related data, operating hours, number of equipment, operating hours, or combinations thereof.

12. The system of claim 9, wherein the first regression model includes
Sᵢₜ=Bᵢ+βᵢ·HDDₜ·GFAᵢ+εᵢₜ, wherein
Sᵢₜ represents other energy source (e.g., steam) usage for building i at month t,
Bᵢ represents monthly base load for building i,
βᵢ represents a coefficient associated with energy usage for heating,
HDDₜ represents heating degree day at month t,
GFAᵢ represents gross flow area,
εᵢₜ represents an error term accounting for part of energy use not attributed to heating or base load consumption.

13. The system of claim 9, wherein the second regression model includes
Bᵢ=Xᵢβ+εᵢ, wherein
Bᵢ represents monthly base load for building i estimated from the first regression model,
β represents a coefficient associated with base load usage due to a building characteristic,
Xᵢ represents one or more building characteristic,
εₜ is an error term accounting for part of energy usage not attributed to building characteristic.

14. The system of claim 8, wherein the module applies a heating degree day density function to the space heating oil consumption by multiplying the space heating oil consumption
$$by \frac{{HDD}_{t}}{{\sum }_{t ∈ ( {t}_{1} , {t}_{2} )} {HDD}_{t}} ,$$
wherein HDDₜ represents heating degree day (HDD) at month t. t₁ represents beginning and ending time periods respectively associated with period of the space heating oil consumption.

15. A computer readable storage medium storing a program of instructions executable by a machine to perform a method of estimating monthly heating oil consumption of a building that uses heating oil and non-oil source of energy, comprising:
receiving yearly consumption of oil data associated with the building;
separating, by a processor applying statistical models, the yearly consumption of oil data into base load oil consumption and space heating oil consumption, the separating step further including determining monthly base load oil consumption associated with the building;
estimating monthly space heating consumption of oil by applying a heating degree day density function to the space heating oil consumption; and
summing the monthly space heating consumption and the monthly base load oil consumption to estimate the monthly heating oil consumption.

16. The computer readable storage medium of claim 15, wherein the statistical models include a first regression model that formulates monthly energy source usage in terms of monthly base load usage and monthly heating usage, and a second regression model that formulates the monthly base load usage in terms of building characteristics.

17. The computer readable storage medium of claim 16, wherein the step of separating includes:
developing the first regression model based on monthly energy usage data associated with one or more buildings that do not use oil as energy source;
determining first monthly base load usage from the developed first regression model;
developing the second regression model based on said first monthly base load usage;
predicting second monthly base load usage associated with the building using the developed second regression model;
estimating monthly non-oil base load usage of the building attributed to non-oil energy source by applying the first regression model using monthly non-oil energy source usage data associated with the building; and
determining the monthly base load oil consumption associated with the building by taking the difference between the predicted second monthly base load usage associated with the building and the monthly non-oil base load usage of the building.

18. The computer readable storage medium of claim 16, wherein the building characteristics include size of the building, gross floor area, age of the building and its equipment, occupancy related data, operating hours, number of equipment, operating hours, or combinations thereof.

19. The computer readable storage medium of claim 16, wherein the first regression model includes
Sᵢₜ=Bᵢ+βᵢ·HDDₜ·GFAᵢ+εᵢₜ, wherein
Sᵢₜ represents other energy source (e.g., steam) usage for building i at month t,
Bᵢ represents monthly base load for building i,
βᵢ represents a coefficient associated with energy usage for heating,
HDDₜ represents heating degree day at month t,
GFAᵢ represents gross flow area,
εᵢₜ represents an error term accounting for part of energy use not attributed to heating or base load consumption.

20. The computer readable storage medium of claim 16, wherein the second regression model includes
Bᵢ=Xᵢβ+εᵢ, wherein
Bᵢ represents monthly base load for building i estimated from the first regression model,
β represents a coefficient associated with base load usage due to a building characteristic,
Xᵢ represents one or more building characteristic,
εₜ is an error term accounting for part of energy usage not attributed to building characteristic.

21. The computer readable storage medium of claim 15, wherein the applying a heating degree day density function to the space heating oil consumption includes multiplying the space heating oil consumption by
$$\frac{{HDD}_{t}}{{\sum }_{t ∈ ( {t}_{1} , {t}_{2} )} {HDD}_{t}} ,$$
wherein HDDₜ represents heating degree day (HDD) at month t. t₁ represents beginning and ending time periods respectively associated with period of the space heating oil consumption.

22. A method for estimating monthly heating oil consumption of a selected building that uses heating oil and non-oil source of energy, comprising:
developing, by a processor, a first regression model to separate monthly base load energy usage from heating energy usage, using data collected from a plurality of buildings that do not use oil for energy;
building a second regression model for the monthly base load energy usage based on one or more building characteristics;
predicting selected building's monthly base load usage by applying the developed second regression model;
estimating selected building's monthly non-oil base load usage attributed to non-oil energy source by applying the first regression model;
determining monthly base load oil consumption associated with a selected building by taking the difference between the predicted monthly base load usage associated with the building and the estimated monthly non-oil base load usage of the building.
estimating monthly space heating consumption of oil by applying a heating degree day density function to the space heating oil consumption; and
summing the monthly space heating consumption and the monthly base load oil consumption to estimate the monthly heating oil consumption.
